(19) United States
(12) Patent Application Publication
(10) Pub. No.: US 2009/0120262 A1
(43) Pub. Date: May 14, 2009

(54) Multifunction Finishing Assembly for Floor Covering, a Method for Manufacturing and a Method for Laying Said Assembly

(75) Inventor: Bernard Proot, Marcq En Baroeul (FR)

Correspondence Address: HARNESS, DICKEY & PIERCE, P.L.C., P.O. BOX 828, BLOOMFIELD HILLS, MI, 48303, US

(73) Assignee: DEPRO FRANCE, Armentieres (FR)

(21) Appl. No.: 11/795,369

(22) PCT Filed: Jan. 17, 2006
(86) PCT No.: PCT/EP06/00362

§ 371 Date: Jul. 16, 2007

(30) Foreign Application Priority Data
Jan. 25, 2005 (FR) 0500736
Jan. 25, 2005 (FR) 0500739

(51) Int. Cl. B26D 1/00; B23P 17/00; B05C 1/00

(52) U.S. Cl. 83/697; 29/527.4; 118/200

(57) ABSTRACT

The finishing assembly for floor covering comprises at least two bars (1;2/1;3), being on the one hand assembled together side by side such that they comprise at least two surfaces (1d;2d/1d; 3d) substantially in the prolongation of one another, and separated by a longitudinal interstice (6/6′), and being, on the other hand, separable. Both assembled bars (1;2/1;3) are designed to be used in a first floor covering application and at least one (1) of said two bars are designed to be used in a second floor covering application. The assembly further comprises a surface coating (4) being applied on both bars (1;2/1;3) and covering the longitudinal interstice (6/6′) between both bars.

### TECHNICAL FIELD

The present invention relates to a multifunction finishing assembly for floor covering, which could be used in at least two different applications, and preferably either as a joint bar between two floor coverings or transition bar, or as a joint bar between two floor coverings or stop bar, or as a joint bar between two floor coverings or transition bar or stop bar.

### PRIOR ART

In the field of floor covering laying or renovation or floor renovation, it is of common practice to use finishing elements in the form of finishing bars, for example, made of wood, metal or plastic, to be fixed to the floor, so as to cover the edge of at least one floor covering. Amongst such finishing elements there are predominantly joint bars, transition bars, stop bars and step ridges. The application for the finishing bar (joint bar, transition bar, stop bar or step ridge) is determined depending on its cross-sectional profile.

Finishing elements for floor covering of the joint bar, transition bar, stop bar or step ridge type are disclosed, for example, in patent applications US2003/0154678 and US2004/0206038, and in U.S. Pat. Nos. 6,745,534, 6,805,951, 6,517,935, in French Patent Applications FR 2,737,237, FR 2,848,234, FR 2,695,671, FR 2,783,854 and in International Patent Application WO 03/040492.

As used herein, the term “joint” bar refers to a bar to be laid on the floor at the interface between two adjacent floor coverings (moquette, carpet, parquet, wooden floor, floor tiles, . . . ). Such a bar type generally has a T-shaped cross-sectional profile. Each T wing is used for covering the edge of one of both coverings and the T foot is used for fixing the bar to the floor, for example by cooperation with a fixing rail or similar permanently secured between both coverings. Thus, the joint bar allows for the joint to be masked between both floor coverings and for a better aesthetics to be given to the transition zone between both floor coverings. Moreover, the joint bar makes it possible, as required, to compensate for and to mask slight thickness differences between both floor coverings.

As used herein, the term “transition” bar refers to a bar being generally used for providing the transition between a floor covering (moquette, carpet, parquet, wooden floor, floor tiles, . . . ) and the floor or between two floor coverings with a significant height offset. The function thereof is therefore to compensate for and to mask significant height differences between a floor covering and the floor or between two floor coverings.

As used herein, the term “stop” bar refers to a bar generally ending at the opposite side of the floor covering with a substantially vertical side. Such a bar type is generally used as a finishing element between a floor covering and a vertical wall such as a wall or a partition.

The “step ridges” are bars having a L-shaped cross-sectional profile and being intended for being fitted on a step angle.

For improving the aesthetics and/or wear resistance of floor covering finishing bars, it is additionally known to apply on such bars, when being manufactured, a surface coating which is, for example, a film or a sheet of material glued with the top surface of the bar. By way of an example, the above-mentioned U.S. Pat. Nos. 6,805,951 and 6,517,935 describe a method for manufacturing a finishing element comprising a thin abrasion-resistant coating being of the multilayer type.

More particularly with a view to simplify the supply management and to offer to the customers a single multiuse product, the finishing bar manufacturers focussed these recent years on the manufacture and marketing of multifunction finishing bar assemblies of the kit type. A multifunction finishing assembly is described for example in International Patent Application WO 03/040492. In said Publication, the multifunction finishing assembly comprises a T-shaped joint bar onto which an additional side bar is embedded. When the additional side bar is assembled with the T-shaped element, the assembly can be used as a transition bar (1^{st} application). For using the assembly as a joint bar (2^{nd} application), it is sufficient to separate the additional bar from the T-shaped bar, the latter being able to be used as a joint bar.

One drawback of multifunction finishing assemblies as known currently lies in the presence of a small width longitudinal gap (interstice) at the junction of the surfaces of the individual bars making up the assembly. Not only does such a gap ruin the aesthetic quality of the finishing assembly, but it also deleteriously results in a brittleness area that could be easily damaged over time and that gets dirty more easily.

### OBJECTIVE OF THE INVENTION

The objective of the present invention is to provide a finishing assembly for floor covering being of the multifunction type and overcoming the above-mentioned drawback related to the presence of an interstitial joint between each individual element of the multifunction assembly.

### SUMMARY OF THE INVENTION

Such an objective is achieved by the finishing assembly for floor covering as claimed in claim 1. As known, in the above-mentioned Publication WO 03/040492, such a finishing assembly comprises at least two bars, being on the one hand assembled together side by side so that they comprise at least two surfaces substantially in the prolongation of one another, and separated by a longitudinal interstice, and being, on the other hand, separable, said assembled bars being designed to be used in a first floor covering application and at least one of said bars being designed to be used in a second floor covering application.

In a characteristic and novel way according to the invention, the finishing assembly comprises a floor covering being applied on said assembled bars and covering the longitudinal interstice between said bars.

More particularly, the multifunction assembly according to the invention comprises the additional and optional technical features such as defined in the appended claims and depending on the main claim 1, said technical features being, depending on the case, considered separately or in combination one with the others.

According to a another aspect of the invention, the multifunction finishing assembly for floor covering according to the invention comprises a central bar having a substantially T-shaped cross section, a monobloc assembly comprising two side bars being connected together by a bridge and being individually separable from the monobloc assembly, the T-shaped central bar being embedded into the monobloc assembly such that the foot of said T-shaped central bar is positioned between both side bars and both wings of the T-shaped bar abutting against both side bars. In such a case, the finishing assembly preferably comprises, but not necessarily, a surface coating being applied on all the bars.

More particularly, the multifunction assembly according to the invention comprises the following additional and optional features considered separately or in combination one with the others:
the finishing assembly comprises at least a fixing rail able to cooperate with the T-shaped central bar foot; more particularly, such a rail is mounted integrally with the monobloc assembly, and preferably, serves as a bridge connecting both side bars together; and
the monobloc assembly is an extruded section.

A second object of the invention is a method for manufacturing the above-mentioned finishing assembly. According to the invention, such a method of manufacturing comprises the following steps:
manufacturing at least two distinct bars with the same length;
assembling said bars side by side such that they have two surfaces substantially in the prolongation one of the other and separated by a longitudinal interstice; and
applying on the bars a surface coating covering the longitudinal interstice.

Preferably, during the manufacture, the bars are temporarily maintained together for enabling the application of the surface coating without moving the bars one in respect to the other. More particularly, when the method is related to the manufacture of a finishing assembly comprising one central bar and two side bars, an intermediate element is being manufactured, said intermediate element consisting of both side bars being connected together by a temporary bridge.

Also, in a particular alternative of the invention, a movable support pedestal is temporarily assembled with the bars, said pedestal allowing to temporarily block said bars together in particular when the assembly is being transported or handled.

A third object of the present invention is to provide a method for laying onto the floor a multifunction finishing assembly.

According to the invention, such a method comprises a step wherein the surface coating is being cut at the level of at least one longitudinal interstice between two bars of the finishing assembly so as to separate said both bars.

A fourth object of the invention is a cutting tool comprising a shoe and a cutting blade being integral with the shoe. The shoe is designed to be positioned on the finishing assembly and to be able to slide along such a finishing assembly while being guided in translation by at least one side bar of said assembly. The cutting blade is positioned and oriented relative to such a shoe, such that once the shoe positioned on the finishing assembly, the cutting blade allows the surface coating to be cut through translation of the shoe along the finishing assembly.

### BRIEF DESCRIPTION OF THE DRAWINGS

Other features and advantages of the invention will be more clearly apparent on reading the herein below detailed description of several preferred alternative finishing assemblies according to the invention, such a description being set forth as a non limitative and non exhaustive example of the invention and referring to the appended drawings wherein:

FIG. 1 is a perspective view of a first alternative embodiment of a multifunction finishing assembly (joint bar/transition bar/stop bar) comprising a section forming a movable pedestal temporarily connecting the side bars of the multifunction assembly and additionally comprising a U-shaped fixing rail,

FIG. 2 is a perspective view of the T-shaped central bar of the assembly as shown on FIG. 1,

FIG. 3 is a perspective view of an intermediate section comprising both side bars of the assembly as shown on FIG. 1, connected by a separable temporary bridge,

FIG. 4 is a perspective view of the T-shaped central bar of FIG. 2 assembled with the intermediate section as shown on FIG. 3,

FIG. 5 is a perspective view of the assembly as shown on FIG. 4 after application of the surface coating onto the bars,

FIG. 6 is a perspective view of the assembly shown on FIG. 5 after cutting the temporary bridge connecting the side bars,

FIG. 7 is a perspective view of the pedestal of the multifunction assembly as shown on FIG. 1,

FIGS. 8, 9 and 10 show applications of the multifunction assembly shown on FIG. 1 respectively as a joint bar, a transition bar and a stop bar,

FIG. 11 is a perspective view of a second alternative embodiment of a multifunction finishing assembly (joint bar/transition bar/stop bar),

FIG. 12 is a perspective view of a third alternative embodiment of a multifunction finishing assembly (joint bar/transition bar/stop bar),

FIGS. 13, 14 and 15 show applications of the multifunction assembly shown on FIG. 12 respectively as a joint bar, a transition bar and a stop bar,

FIG. 16 is a perspective view of a fourth alternative embodiment of a multifunction finishing assembly (joint bar/transition bar/stop bar),

FIGS. 17, 18 and 19 shown applications of the multifunction assembly shown on FIG. 16 respectively as a joint bar, a transition bar and a stop bar,

FIG. 20 is a perspective view of a fifth alternative embodiment of the multifunction finishing assembly (joint bar/transition bar/stop bar),

FIG. 21 is a perspective view of two U-shaped fixing rails one embedded into the other and separable, said rails being intended to be used for fixing to the floor the finishing assembly shown on FIG. 20,

FIG. 22 shows the multifunction assembly shown on FIG. 20 used as a joint bar,

FIGS. 23 and 24 respectively show two different applications of the multifunction assembly shown on FIG. 20 as a transition bar,

FIGS. 25 and 26 respectively show two different applications of the multifunction assembly shown on FIG. 20 as a stop bar,

FIG. 27 is a perspective view of a sixth embodiment of a multifunction finishing assembly (joint bar/transition bar/stop bar),

FIG. 28 is a perspective view of two fixing rails respectively with U-shaped and T-shaped, one embedded into the other and separable, said rails being intended to be used for fixing to the floor the finishing assembly shown on FIG. 27,

FIGS. 29, 30, and 31 show applications of the multifunction assembly as shown on FIG. 12 respectively as a joint bar, a transition bar and a stop bar,

FIG. 32 is a perspective view of a seventh alternative embodiment of a multifunction finishing assembly (joint bar/transition bar/stop bar) and of a tool for cutting the surface coating, and

FIG. 33 shows the cutting tool in a cutting position on the finishing assembly shown on FIG. 32.

### DETAILED DESCRIPTION

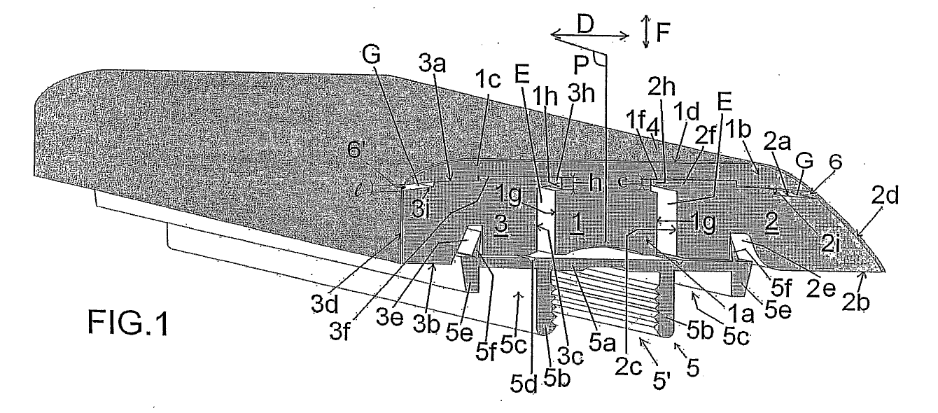

On FIG. 1 there is shown a finishing assembly for a floor covering according to a first preferred embodiment of the invention, and which could be used in three different applications either as a joint bar, a transition bar or a stop bar.

Such a finishing assembly consists in five elements:
three finishing bars, with the same length, and for example, made of wood, namely a central bar 1, and two side bars 2 and 3 arranged on both sides of the central bar,
a surface coating 4 applied onto the three finishing bars 1, 2 and 3, and
a pedestal 5, for example, in plastic.

The two side bars 2 and 3 have different cross-sectional profiles (i.e., in a plane perpendicular to their longitudinal axis).

When being used on its own, the finishing bar 1 is a joint bar (1^{st} application). Both bars 1 and 2, when they are used together, form a transition bar (2^{nd} application). Both bars 1 and 2, when being used together, form a stop bar (3^{rd} application).

In particular, in the illustrated example, the joint bar 1 is symmetrical according to a median longitudinal plane (P) and has a T-shaped cross section, with a central pedestal 1a, and two side wings 1b and 1c being identical and symmetrical with one another relative to the plane P. The bar 1 comprises a top surface 1d being planar in its central part and having a circle arc-shaped curve at the level of both wing 1b and 1c ends.

The side bar 2 is a distinct part of the above-mentioned bar 1 and is positioned side by side with the bar 1 between the central foot 1a and the wing 1b. The bar 2 comprises a top face 2a, being partially in contact with the bottom face of the wing 1b, a bottom face 2b, an internal side face 2c directed to the central foot 1a of the bar 1 and a slightly curve external side face 2d. The external side face 2d of the bar 2 lies in the extension of the top face 1d of the central bar 1, a longitudinal interstice 6 separating both faces 1d and 2d throughout the length of the bars 1 and 2.

The bar 3 is a part distinct from the above-mentioned bar 1 and is positioned side by side with the bar 1 between the central foot 1a and the wing 1c. The bar 3 comprises a top face 3a, partially coming in contact with the internal face of the wing 1b, a bottom face 3b, an internal side face 2c directed toward the central foot 1a of the bar 1, and an external side face 3d being substantially planar and perpendicularly directed toward the planar central part of the top face 1d of the bar 1. The external side face 3d of the bar 2 lies in the prolongation of the top face 1d of the central bar 1, a longitudinal interstice 6′ separating both faces 1d and 3d throughout the length of the bars 1 and 3.

The surface coating 4 is a flexible rectangular-shaped sheet of material (monolayer or multilayer), being applied and fixed through any known means and for example, through gluing by means of an adhesive, on the top face 1d of the bar 1 and on the external side faces 2d and 3d respectively of the bars 2 and 3. The surface coating 4 covers all the above-mentioned surfaces 1d, 2d, and 3d, and essentially covers and masks advantageously the two longitudinal interstices 6 and 6′. The three bars 1, 2 and 3 are thus retained together through such a surface coating 4.

More generally, within the scope of the invention, the “surface coating” of the finishing assembly may comprise any coating having a thin thickness being able to match the curved surface of the individual bars on the finishing assembly, whatever the nature of the material(s) making up the coating and whatever the technique used for applying the coating on the bars of the finishing assembly. In particular, the coating could indiscriminately be of the monolayer or of the multilayer type. It could for example comprise a film or a sheet, made in plastic, in paper, in wood, or be made in any known fabric (non woven, woven fabric). Preferably, but not necessarily, the coating will be decorative and/or will have improved mechanical wear resistant properties. Preferably, but not necessarily, the surface coating is glued (cold or heat glued) on the bars of the finishing assembly.

The pedestal 5 is a section, preferably made in plastic, with the same length as the bars 1, 2 and 3. It comprises a base plate 5a and two identical, parallel longitudinal walls 5b, substantially perpendicular to the base plate 5a. Those both walls 5b form together with the base plate 5a, a U-shaped rail 5′, for fixing on the floor the bar(s) of the finishing assembly.

In the particular alternative embodiment of FIG. 1, the pedestal 5 further comprises two side wings 5c extending the base plate 5a on both sides of the U-shaped fixing rail 5′. Each side wing 5c is separable relative to the U-shaped rail 5′. Preferably, in order to facilitate the separation through cutting each side wing 5c, a V-shaped longitudinal groove 5d is provided at each joint between the U-shaped fixing rail 5′ and each side wing 5c, said V-shaped groove 5d making up a separation line with a lower thickness.

More particularly, both side bars 2 and 3 comprise respectively in the lower sides 2b, 3b thereof two longitudinal grooves 2e and 3e. Each side wing 5c of the pedestal 5 ends at a longitudinal retaining stud 5e being designed to be embedded, preferably by tightening, into one of the grooves 2e or 3e.

More particularly, each wing 5c of the pedestal 5 comprises an additional longitudinal stud 5f being separable. Referring to FIG. 1, the additional studs 5f are housed into the two above-mentioned longitudinal grooves 2e and 3e, such that the pedestal 5 is temporarily assembled with the two side bars 2 and 3. Preferably, both studs 5f are slightly resiliently flexible relative to the base plate 5a, such that the pedestal 5 is made integral through nipping of the bars 1, 2 and 3 between both temporary studs 5f.

In the embodiment on FIG. 1, the pedestal 5 advantageously makes it possible to block in position the side bars 2 and 3 abutting against the bar 1, and more particularly prevents the side bars 2 and 3 from moving relative to the side bar 1 in a plane parallel to the cross-section of the bars. The assembly 1, 2, 3, 4 and 5 thus makes up a ready-to-use multifunction finishing assembly, able to be advantageously easily handled and/or transported and/or offered for sale. When being offered for sale, such an assembly could be obviously wrapped with the user's guide, in a transparent plastic wrap.

In particular, in the alternative embodiment shown on FIG. 1, the bottom face 1e of each wing 1b and 1c of the central bar 1 comprises a blocking longitudinal groove 1f forming a double abutment, into which is positioned a projecting longitudinal part 2f or 3f of the bar 2 or 3. Said projecting part 2f or 3f allows to laterally block in translation the side bar 2 or 3 relative to the central bar 1 following an axis D perpendicular to the median longitudinal plane P of the bar 1.

Preferably, the side faces 1g of the central foot 1a of the bar 1 comprise a longitudinal groove 1h forming a double abutment, into which is to be arranged a projecting longitudinal part 2h (respectively 3h) of the bar 2 (respectively the bar 3), allowing the bar 2 (respectively the bar 3) to be blocked in translation relative to the foot 1a of the bar 1 in a plane parallel to its cross sectional section and along an axis F perpendicular to the above-mentioned axis D.

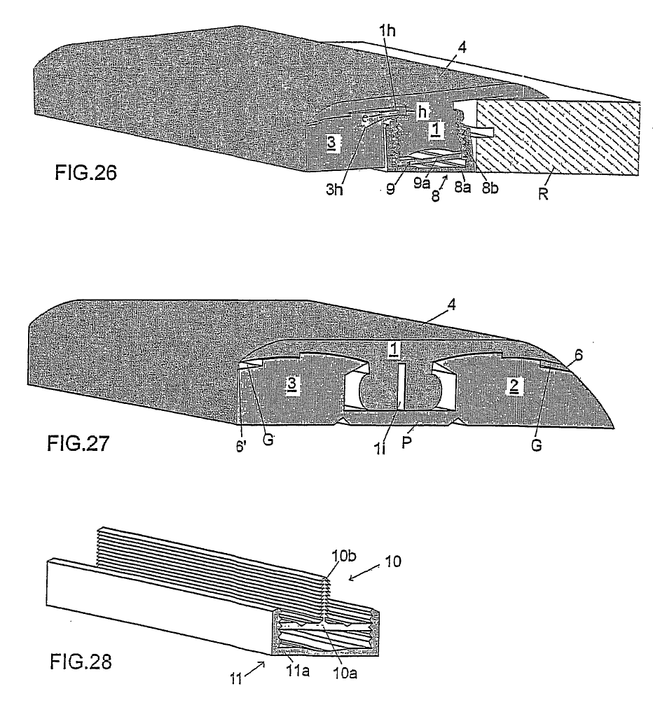

Preferably, the thickness (e) of the projecting longitudinal part 2h (respectively 3h) of the bar 2 (respectively the bar 3) is lower than the height (h) of the groove 1h such that there should be, between the bar 2 (respectively the bar 3) and the bar 1, a slight play advantageously allowing for a slight motion of the bar 2 (respectively bar 3) relative to the bar 1 in a plane parallel to the cross-section of the bars. The utility of such a clearance will be more clearly obvious referring to FIG. 26.

Advantageously, the projecting longitudinal parts 2h and 3h allow on both sides of the foot 1a of the central bar 1, for providing a longitudinal space E being able to serve as a housing for the walls 5b of the fixing rail 5′ of the pedestal 5.

According to an additional preferred feature, the side bar 2 (respectively the side bar 3) comprises a longitudinal recess 2i (respectively 3i) extended throughout the length of the bar and being arranged opposite to the bottom face of the wing 1b (respectively wing 1c) of the bar 1. Such a recess 2i (respectively 3i) delimits with the bottom face of the wing 1b (respectively wing 1c) of the bar 1, a groove G with a low width (l) allowing a cutting blade to be inserted and guided. The entry of such a groove G corresponds to the interstice 6 or 6′. Practically, the width (l) of the groove will be preferably higher than 0.6 mm.

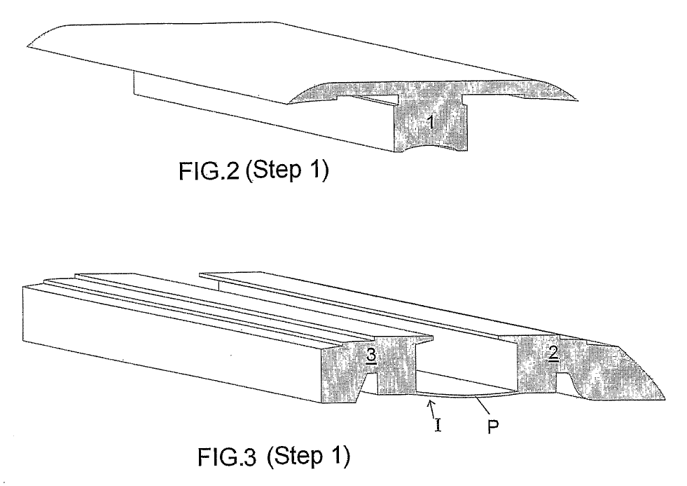

FIG. 2 to 7 illustrate the main successive steps for manufacturing the finishing assembly of FIG. 1.

### Step 1 (FIGS. 2 and 3)

The joint bar 1 and the intermediate part I are manufactured with two bars 2 and 3 connected throughout their length by a separable temporary longitudinal bridge P. Depending on the material type, such parts 1 and I are manufactured, for example, through machining (wooden parts) or through extrusion (plastic or metal parts).

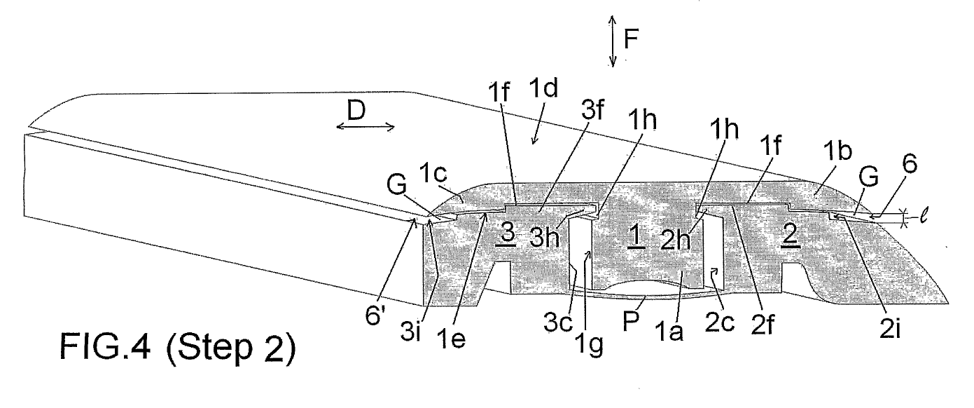

### Step 2 (FIG. 4)

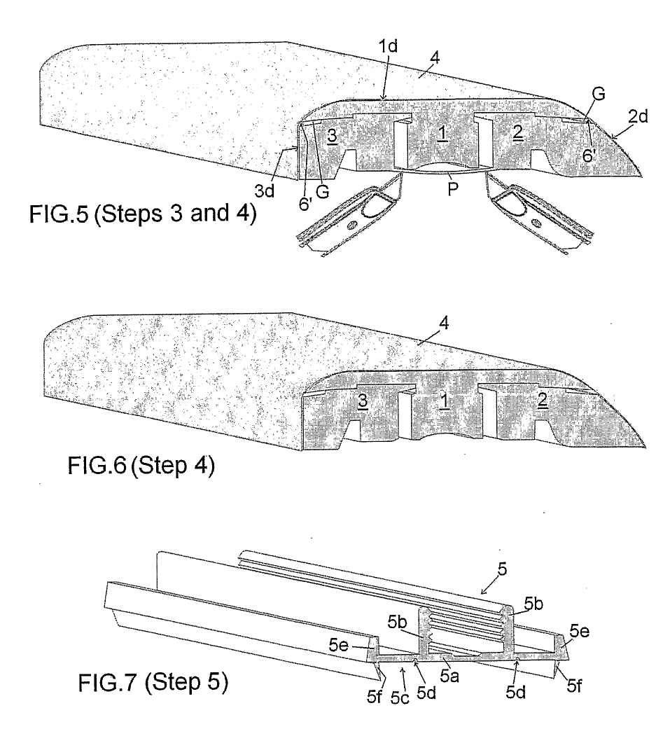

Through a simple embedment, the bar 1 is interfitted with the intermediate part I, the foot 1a of the bar 1 being housed into the longitudinal space delimited by both external side faces 2c and 3c opposite the bars 2 and 3 and by the temporary bridge P. During this assembling operation, the projecting parts 2f and 3f of the bars 2 and 3 are housed in the corresponding grooves 1f of the bar 1, allowing the bar 2/bar 3/temporary bridge P assembly to be centred relative to the bar 1. As a result, the bars 2 and 3 are perfectly positioned and maintained in position relative to the bar 1 during the subsequent application operation of the surface coating 4 (Step 3/FIG. 5).

### Step 3 (FIG. 5)

The surface coating 4 is applied and glued on the assembly formed by the parts 1 and I, so as to totally cover the faces 1d, 2d and 3d of the bars 1, 2 and 3. The application and gluing technique of such a coating is known per se and will therefore not be detailed in the present application. The temporary bridge P advantageously makes it possible to maintain the bars 2 and 3 relative to the bar 1 during the application operation of the surface coating 4.

Once applied, the surface coating 4 advantageously masks both interstices 6 and 6′.

### Step 4 (FIGS. 5 and 6)

The temporary bridge P connecting the bars 2 and 3 is removed by cutting it using a cutting tool (for example, a cutting blade (FIG. 5) or a saw), so that the bars 2 and 3 are no longer directly integral with one another (FIG. 6). The bars 1, 2 and 3 are maintained together by the surface coating 4.

### Step 5 (FIGS. 7 and 1)

The pedestal 5, being previously manufactured (FIG. 7) for example through extrusion, is assembled with the previously formed bar 1/bar 2/bar 3/coating 4 assembly, so as to form the finishing assembly as shown on FIG. 1. Such an assembly operation could be simply achieved embedding or interfitting the side bars 2 and 3 onto separable temporary studs 5f of the pedestal 5. In such a configuration of FIG. 1, the pedestal 5 advantageously allows the above-mentioned temporary bridge P to be replaced, mechanically connecting both bars 2 and 3 together, and maintaining them applied on the central bar 1. The finishing assembly shown on FIG. 1 could thus be handled without risking to move the bar 2 or the bar 3 relative to the bar 1 and thereby without risking to damage the coating 4.

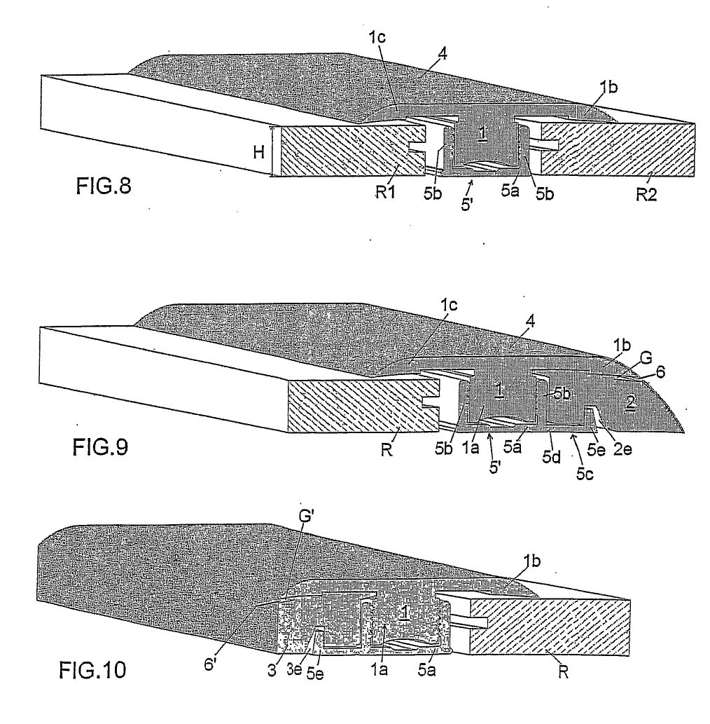

The various usage possibilities of the finishing assembly according to FIG. 1 will now be detailed referring to FIGS. 8 to 10.

### Use as a Joint Bar (FIG. 8)

On FIG. 8 there is shown the implementation of the central bar 1 of the assembly as in FIG. 1 as a joint bar, interposed between both floor coverings R1 and R2 having substantially the same height H relative to the floor. It could be any known type of floor covering (wooden floor, moquette, carpet, parquet, wooden floor, floor tiles, linoleum, . . . ). In order to achieve the implementation of FIG. 8, it is sufficient for the final user having the finishing assembly shown on FIG. 1 to perform the following operations.

The pedestal 5 is released from the bars 2 and 3 of the finishing assembly. The pedestal 5 is cut along both V-shaped grooves 5d so as to only keep the U-shaped fixing rail 5′. The coating 4 is cut using a blade or similar, along each longitudinal groove G, so as to separate the side bars 2 and 3 (and their surface coating 4 portion), from the central bar 1 and its surface coating 4 portion. The width (l) of each interstice 6, 6′ being sufficient for sliding a cutting blade into the groove G, advantageously a sharp cutting of the coating 4 is achieved.

Subsequently, the base 5a of the U-shaped fixing rail 5′ is fixed to the floor between both coverings R1 and R2, using any appropriate means selected more specially depending on the nature of the floor (for example, screwing and/or gluing). The central foot 1a of the bar 1 is inserted into both arms 5b of the rail 5′ and pushing it until both wings 1b and 1 of the bar come into contact with the surface of both coverings R1, R2. Preferably, the internal side of both arms 5b is notched so as to allow the joint bar 1 to be blocked in position at different heights, depending on the height H of the coverings.

### Use as a Transition Bar (FIG. 9)

There is shown on FIG. 9, the implementation of the finishing assembly of FIG. 1 as a transition bar between a floor covering R and the floor underlying such a floor covering. In order to achieve the implementation of FIG. 9, it is sufficient for the final user having the finishing assembly shown on FIG. 1 to perform the following operations.

The pedestal 5 is released from the bars 2 and 3 of the finishing assembly. The pedestal 5 is cut manually along one of the V-shaped grooves 5d so as to only keep the U-shaped fixing rail 5′ and a side wing 5c, the other side wing 5c being removed. The temporary stud 5f is cut from the remaining wing 5c.

The coating 4 is cut manually using a blade or similar, slid into the groove G, so as to separate the side bar 3 (and its surface coating 4 portion), from the remaining assembly: bar 1/bar 2/coating 4 covering the bars 1 and 2.

Subsequently, the base 5a of the U-shaped fixing rail 5′ is fixed to the floor along the covering R edge using any appropriate means selected more specially depending on the nature of the floor (for example, screwing and/or gluing).

The foot 1a of the central bar 1 is inserted between the U-shaped rail 5′ and the longitudinal retaining stud 5e into the bottom groove 2e of the bar 2. The bar 1/bar 2/coating 4 assembly is pushed until the wing 1c of the bar 1 comes into contact with the covering R surface.

### Use as a Stop Bar (FIG. 10)

There is shown on FIG. 10 the implementation of the finishing assembly of FIG. 1 as a stop bar between a floor covering R and the floor underlying such a floor covering. In order to achieve the implementation of FIG. 9, it is sufficient for the final user having the finishing assembly shown on FIG. 1 to perform the same operations as previously described for applying the transition bar, but substituting in the explanations bar 3 for bar 2.

Referring to FIG. 9 (transition bar) and to FIG. 10 (stop bar), it is understood that the coating 4 covering the interstitial joint 6 and 6′ respectively, it advantageously allows to protect it against any fouling and to mask it, improving the aesthetics of the finishing. In addition, any releasing or damaging risk of the surface coating 4 is prevented at the level of the joint between both bars 1 and 2, or between the bars 1 and 3.

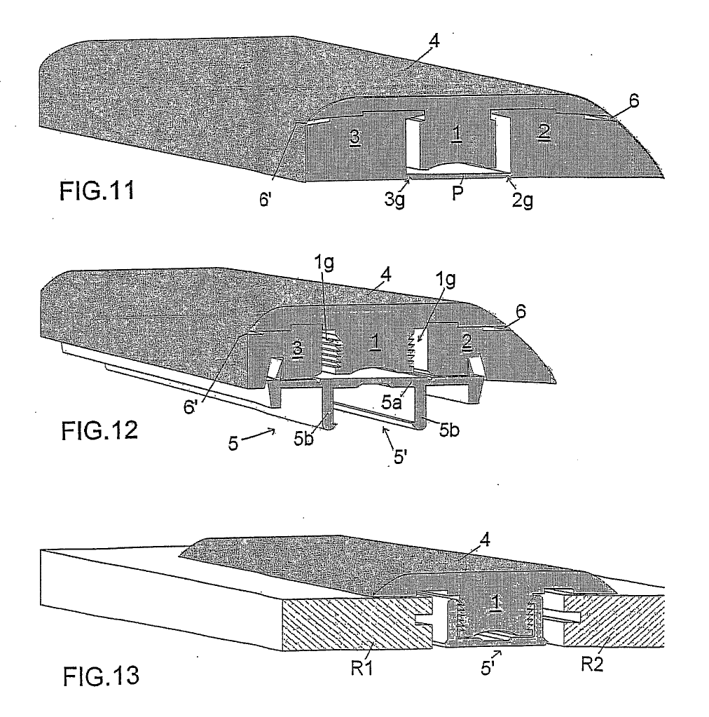

There is shown on FIG. 11 another further embodiment of the finishing assembly according to the invention, being distinct from the finishing assembly shown on FIG. 1, due to the absence of the pedestal 5 and of the presence of a temporary bridge P connecting between one another both side bars 2 and 3. At the joint between such a bridge and respectively both bars 2 and 3 are arranged V-shaped longitudinal grooves 2g and 3g. The bridge P is to be used for fixing to the floor, for example, through gluing or screwing, the bar 2 or the bar 3 depending on the selected application (transition bar or stop bar) after the other bar unused in the application has been separated from the bridge P.

There is shown on FIG. 12 a third alternative embodiment of a finishing assembly according to the invention. In such an alternative, the side faces 1g of the central foot 1a of the T-shaped central bar 1 are notched so as to allow the foot 1a to be adjusted in height in the U-shaped fixing rail 5′.

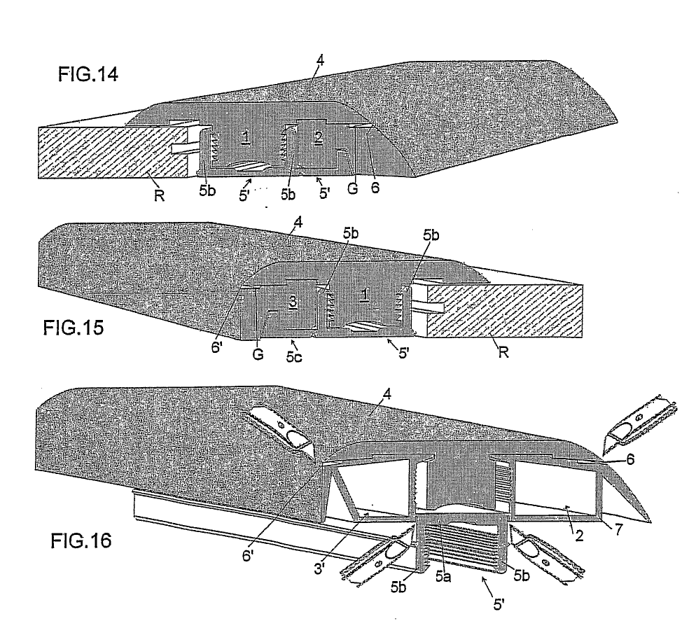

FIGS. 13, 14 and 15 show the finishing assembly of FIG. 12, respectively used as a joint bar, a transition bar and a stop bar.

There is shown on FIG. 16 a fourth alternative embodiment of a finishing assembly according to the invention. In such an alternative, the bars 2 and 3 as well as the U-shaped fixing rail 5′ are integrally part of a sole monobloc assembly 7. Such a monobloc assembly 7 is preferably a plastic extruded section.

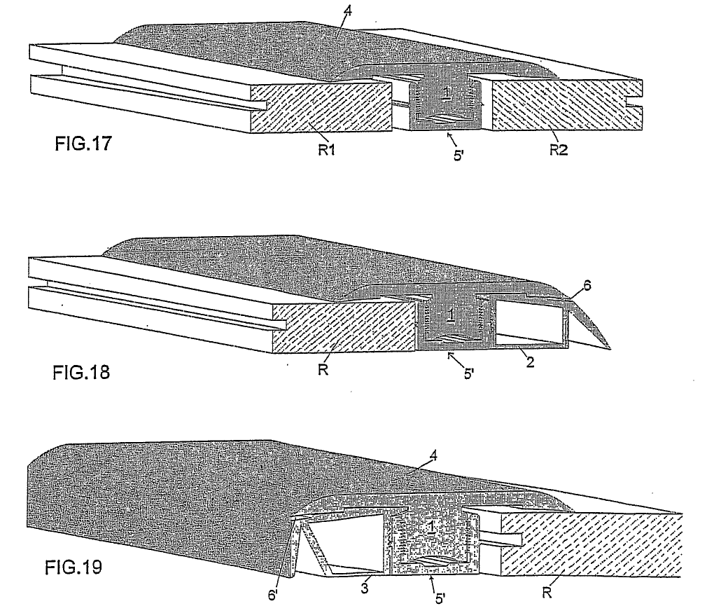

FIGS. 17, 18 and 19 show the finishing assembly of FIG. 16 respectively used as a joint bar, a transition bar and a stop bar. It is to be noted that for FIGS. 18 and 19, the bars 2 and 3 were previously separated through cutting the U-shaped rail 5′.

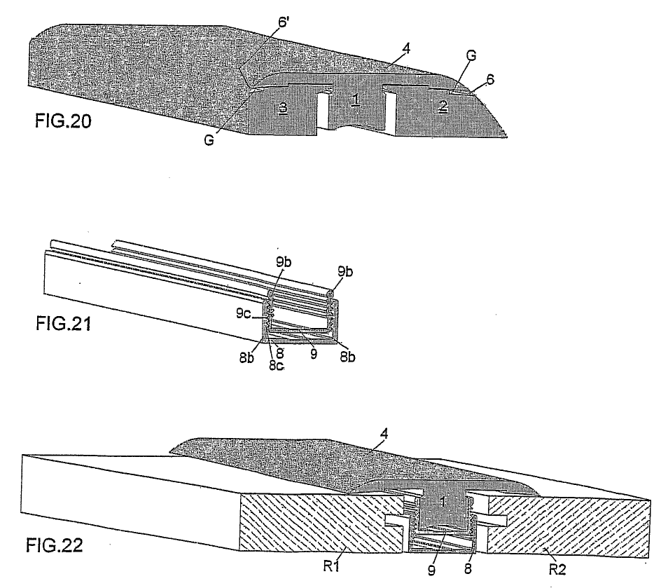

There is shown on FIG. 20 a fifth alternative embodiment of a finishing assembly according to the invention, being intended to be used with both U-shaped fixing rails 8 and 9 shown on FIG. 21. The rail 8 is a U-shaped section having its side walls 8b notched on their internal faces. The rail 9 is a U-shaped section having its side walls 9b notched on their external and internal faces. The rail 9 could additionally be embedded into the rail 8 and adjusted in height relative to the rail 8 in cooperation of its external notches 9c with the internal notches 8c of the rail 8.

FIG. 22 shows the finishing assembly of FIG. 20 configured as a joint bar and fixed to the floor at the joint between both coverings R1 and R2 using both embedded rails of FIG. 21.

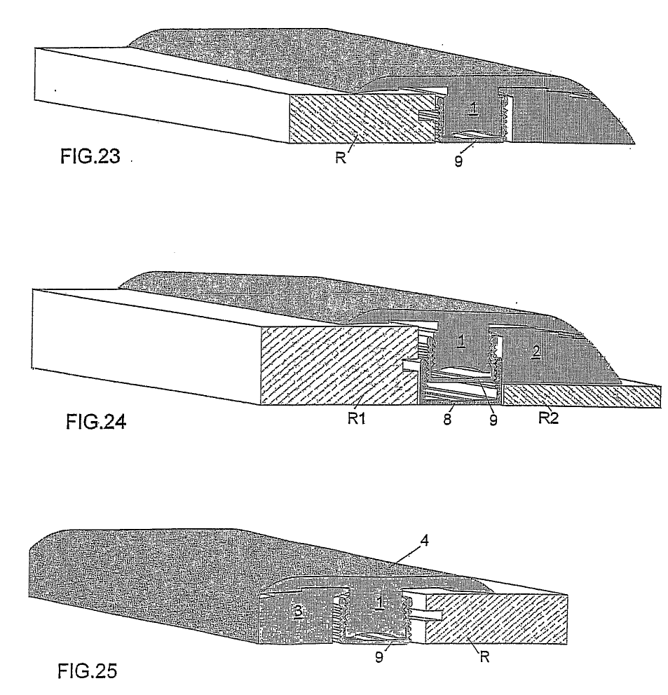

FIG. 23 shows the finishing assembly of FIG. 20 configured as a transition bar and used for a transition between the floor covering R and the floor, said finishing assembly being fixed to the floor by means of the rail 9 only.

FIG. 24 shows the finishing assembly of FIG. 20 configured as a transition bar and fixed for a transition between both floor coverings R1 and R2 having a significant offset in height one relative to the other. In such an application, the finishing assembly is fixed to the floor by means of both embedded rails 8 and 9.

FIG. 25 shows the finishing assembly of FIG. 20 configured as a stop bar and used for a transition between a floor covering R and the floor, said finishing assembly being fixed to the floor by means of the rail 9 only.

FIG. 26 shows the finishing assembly of FIG. 20 configured as a stop bar and used for a transition between a floor covering R and the floor, said finishing assembly being fixed to the floor by means of both embedded rails 8 and 9. In the application as illustrated on said figure, both rails 8 and 9 are off-centred one relative to the other, the base 9a of the rail 9 being not parallel to the base 8a of the rail 8 but forming with said base 8a an angle A, so as to allow the level to be compensated for between the floor and the covering R. Such a rail 9 tilting relative to the rail 8 is achieved slightly forcibly deforming the side branches 8b of the U-shaped rail 8 relative to its base 8a. In addition, it is to be noted that in such an embodiment (as well as the alternative embodiments shown on FIG. 1 and on FIG. 16), such a tilting is achievable by means of some play existing between the groove 1h and the projecting part 3h of the bar 3 (slightly lower dimension (e) at the level (h) of the groove 1h), said play allows the bar 3 to be moved relative to the bar 1, in a plane parallel to the cross-section of the bars.

There is shown on FIG. 27 a sixth alternative embodiment of a finishing assembly according to the invention, being intended to be used with both fixing rails 10 and 11 of FIG. 28.

The rail 11 comprises a U-shaped section. The rail 10 comprises a T-shaped section and can be embedded at various heights into the U-shaped section 11.

In the finishing assembly of FIG. 27, the foot 1a of the T-shaped bar 1 comprises a longitudinal groove 1 allowing for said bar to be embedded onto the foot 10b of the T-shaped rail 10. Both side bars 2 and 3 are connected to one another by a separable temporary bridge P, being intended to be cut when the finishing assembly is being arranged on the floor.

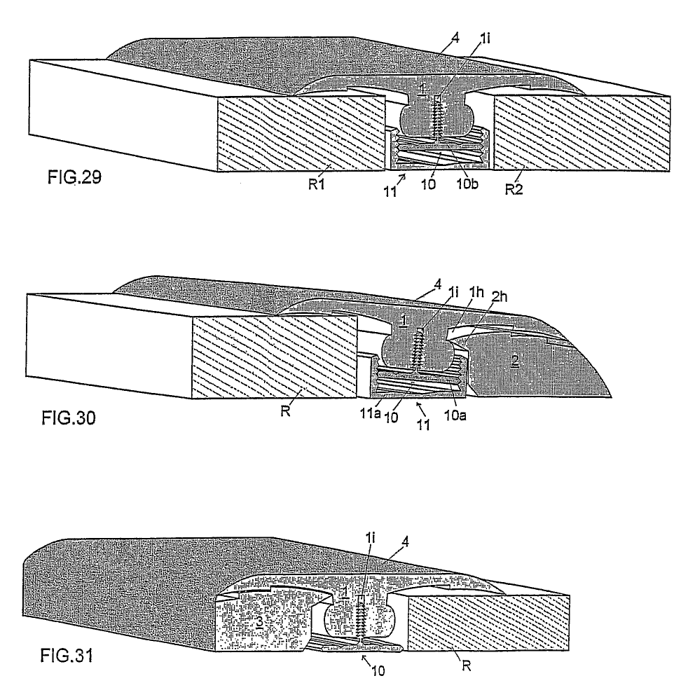

FIG. 29 shows the finishing assembly of FIG. 27 configured as a joint bar and used for a transition between both floor coverings R1 and R2. In such an application, the finishing assembly is fixed to the floor using two rails 10 and 11 one embedded into the other, the groove 1i of the T-shaped central bar 1 being embedded into the T-shaped fixing rail 10, and the rail 11 being fixed using any other means (gluing, screwing, . . . ).

FIG. 30 shows the finishing assembly of FIG. 27 configured as a transition bar and used for a transition between a floor covering R and the floor, said finishing assembly being fixed to the floor by means of both embedded rails 10 and 11. In such an application, the bars 1 and 2 are spaced apart from one another in a plane parallel to their cross-sections, the base 10a of the T-shaped rail 10 being tilted relative to the base 11a of the U-shaped rail 11. Similarly to the application on FIG. 26, such a tilting is achievable by means of some play existing between the groove 1h and the projecting part 2h of the bar 2, said play allows the bar 2 to be moved relative to the bar 1, in a plane parallel to the cross-section of the bars.

FIG. 31 illustrates the finishing assembly of FIG. 27 configured as a stop bar and used for a transition between a floor covering R and the floor, said finishing assembly being fixed to the floor by means of the T-shaped fixing rail 10 only.

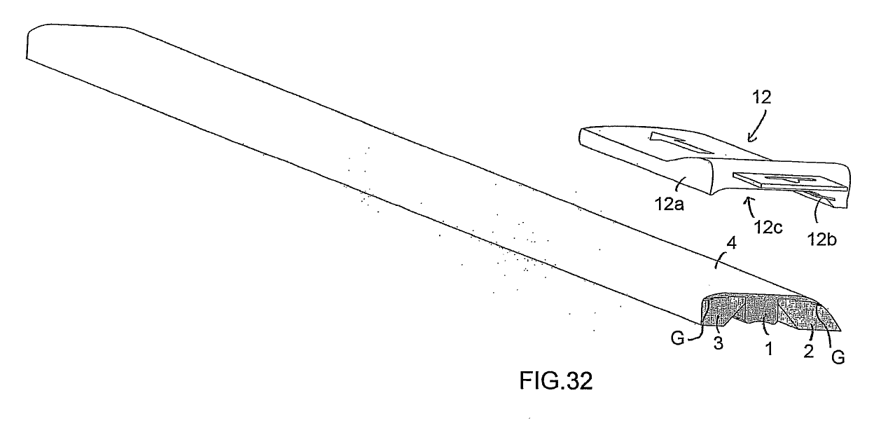

There is shown on FIG. 32 a seventh alternative embodiment of a multifunction finishing assembly (1, 2, 3, 4) according to the invention and a cutting tool 12. Fixing to the floor of such a finishing assembly occurs by means for example of at least one fixing rail (not shown on FIG. 32) into which is embedded the foot of the central bar 1, similarly to what has been previously described for the six other alternative embodiments on FIGS. 1 to 31.

The cutting tool 12 comprises a shoe 12a and a cutting blade 12b integral with said shoe 12a. The foot 12 is for example a plastic moulded part. The shoe 12a comprises a face 12c (referred to as the bottom face) having a U-shaped recess shape. Said bottom face 12c allows the shoe to be positioned on the finishing assembly (1, 2, 3, 4) and said shoe 12a to be guided in translation by both side bars 2 and 3 along the longitudinal axis of the finishing assembly. The cutting blade 12b is positioned and oriented relative to the shoe 12a, such that once the shoe 12a being positioned on the finishing assembly (1, 2, 3, 4), the cutting blade 12b penetrates into one of the longitudinal grooves G of the finishing assembly.

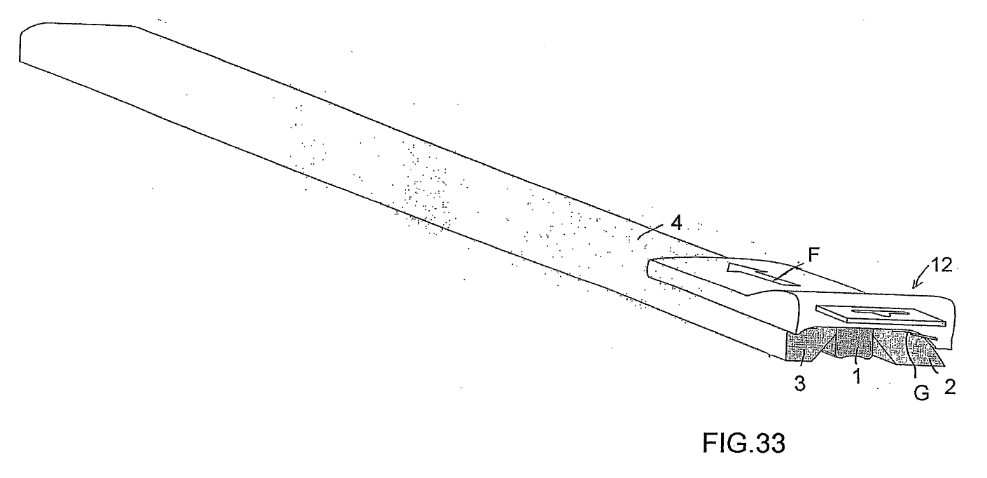

There is shown on FIG. 33 the cutting tool 12 positioned on the end of the finishing assembly shown on FIG. 32. The cutting blade 12b partially penetrates into the longitudinal groove G between the central bar 1 and the side bar 2. By sliding the tool 12 along the finishing assembly (arrow F), the surface coating 4 is very easily and very accurately cut along said longitudinal groove G, allowing to separate the section 2 from the central section 1. For separating, as required, the other section 3 from the central section 1, it is sufficient to reverse the positioning of the cutting tool 12, so that the cutting blade 12b penetrates into the longitudinal groove G between the central blade 1 and the side bar 3.

A similar cutting tool could be used for cutting the surface coating 4 of the other previously described alternative embodiments of finishing assembly.

The present invention is not limited to manufacturing a multifunction assembly comprising three bars 1, 2 and 3, but could be generalized so as to achieve a multifunction finishing assembly comprising at least two bars, onto which is applied the same surface coating. For example, a multifunction assembly could be achieved only comprising one T-shaped bar 1 and one bar 2 and usable as a joint bar or a transition bar as well as a multifunction assembly comprising only one T-shaped bar 1 and one bar 3, and usable as a joint bar or a stop bar.

In addition, the cross-sections of the bars of the finishing assemblies of the appended figures were given only by way of non exhaustive examples of embodiments, the invention being not limited to these only sections. The invention could be equally applied for achieving multifunction finishing assemblies for floor covering having their bars with cross-sections different from those illustrated on the appended figures. Moreover, the bars of the finishing assembly of the invention, depending on their cross-sections, could, as required, fulfil other functions than the functions illustrated on the figures (joint bar, transition bar or stop bar). Within the scope of the invention, a finishing assembly could be achieved for a floor covering being able to be used in other applications for floor covering, and for example, that could be configured for a use as a step ridge.

1. A finishing assembly for floor covering comprising at least two bars 3, being on the one hand assembled together side by side such that they comprise at least two surfaces substantially in the prolongation of one another, and separated by a longitudinal interstice, and being, on the other hand, separable, said assembled bars being designed to be used in a first floor covering application and at least one of said bars being designed to be used in a second floor covering application, characterized in that it comprises a surface coating being applied on said assembled bars and covering the longitudinal interstice between said bars.

2. The assembly according to claim 1, wherein at least two bars have cross-sections that are different.

3. The finishing assembly according to claim 1, wherein it comprises three bars having preferably three different cross-sections, the surface coating being applied on all three bars.

4. The finishing assembly according to claim 1, wherein it is designed to be used either as a joint bar or as a transition bar, or as a joint bar or a stop bar, or as a joint bar or a transition bar, or a stop bar.

5. The finishing assembly according to claim 1, wherein one of the bars has a T-shaped cross-section and at least another bar referred to as a side bar is juxtaposed to said T-shaped bar, being maintained abutting against the T-shaped bar.

6. The assembly according to claim 5, wherein a longitudinal space is arranged between the foot of the T-shaped bar and the side bar, said space being able to serve as a housing for a part of a means for fixing to the floor the T-shaped bar.

7. The assembly according to claim 5, wherein the side bar and the T-shaped bar are assembled with a slight play allowing for a slight motion of the bars one relative to the other in a plane parallel to their cross-sections.

8. The assembly according to claim 5, wherein at least one of the wings of the T-shaped bar comprises in its bottom face a blocking longitudinal groove and in that the side bar comprises a projecting longitudinal part positioned in said groove so as to block in translation the side bar relative to the T-shaped bar.

9. The assembly according to claim 5, wherein at least one of the side faces of the foot of the T-shaped bar comprises one blocking longitudinal groove and in that the side bar comprises a projecting longitudinal part being provided in said blocking groove so as to block in translation the side bar relative to the T-shaped bar.

10. The assembly according to claim 7, wherein there is some play between the projecting longitudinal part and the blocking groove so as to allow for said relative movement of the side bar relative to the T-shaped bar in a plane parallel to the cross-section of both bars.

11. The assembly according to claim 1, wherein it comprises a first central bar having one T-shaped cross-section and two side bars positioned on both sides of the foot of the T-shaped central bar.

12. The assembly according to claim 11, wherein it comprises a pedestal being integral with both side bars, allowing both side bars to be maintained relative to the central bar and which could be separated from both side bars.

13. The assembly according to claim 12, wherein the pedestal comprises a fixing rail able to receive the foot of the T-shaped central bar.

14. The assembly according to claim 12, wherein each side bar comprises a bottom longitudinal groove ensuring it to be retained to the floor, and in that the pedestal comprises for each side bar, a side wing being separable and comprising a longitudinal retaining stud able to be embedded into said bottom longitudinal groove.

15. The assembly according to claim 11, wherein both side bars are connected to one another by bridge, and preferably by a separable bridge.

16. The assembly according to claim 11, wherein both side bars are integrally part of a monobloc assembly and are separable from said assembly.

17. The assembly according to claim 16, wherein the monobloc assembly comprises a fixing rail able to receive the foot of the T-shaped bar.

18. The assembly according to claim 1, wherein between both juxtaposed bars is arranged a groove of small width for inserting and guiding a cutting blade along the longitudinal interstice, during a cutting operation of the surface coating.

19. The assembly according to claim 1, wherein it comprises two fixing rails able to be embedded one into the other at different heights.

20. A method for manufacturing a finishing assembly according to claim 1, wherein it comprises the following steps:
manufacturing at least two distinct bars with the same length;
assembling said bars side by side such that they have two surfaces substantially in the prolongation one of the other and separated by a longitudinal interstice; and
applying on the bars a surface coating covering the longitudinal interstice.

21. The method according to claim 20, wherein prior to applying the surface coating, the bars are temporarily maintained together, for enabling the application of the surface coating without moving the bars one with respect to the other.

22. The method according to claim 21, for manufacturing a finishing assembly comprising a central bar and two side bars wherein an intermediate part is manufactured, said intermediate part consisting of the two side bars connected together by a temporary bridge.

23. The method according to claim 20, wherein a moveable retaining pedestal is temporarily assembled with the bars, said pedestal allowing to temporarily block said bars together in particular when the assembly is being transported or handled.

24. A method for laying onto a floor a finishing assembly according to claim 1 said method comprising a cutting step of the surface coating at the level of at least one longitudinal interstice between both bars so as to separate said both bars.

25. A cutting tool for implementing the method according to claim 24, wherein it comprises on the one hand a shoe designed to be positioned on the finishing assembly and for gliding along said finishing assembly being guided in translation by at least one side bar of said assembly, and on the other hand, a cutting blade, assembled with the shoe and being positioned and oriented relative to the said shoe, so that once the shoe is positioned on the finishing assembly, the cutting blade makes it possible to cut the surface coating through translation of the shoe along the finishing assembly.
